(19) United States
(12) Patent Application Publication
(10) Pub. No.: US 2022/0341656 A1
(43) Pub. Date: Oct. 27, 2022

(54) REFRIGERATION APPLIANCE DEVICE

(71) Applicant: BSH Hausgeräte GmbH, Muenchen (DE)

(72) Inventors: Joachim Betz, Boebingen/ Rems (DE); Hans Ihle, Giengen (DE); Michael Neumann, Ulm (DE)

(21) Appl. No.: 17/639,506

(22) PCT Filed: Aug. 19, 2020
(86) PCT No.: PCT/EP2020/073190

§ 371 Date: Mar. 1, 2022

(30) Foreign Application Priority Data
Sep. 4, 2019 (DE) 10 2019 213 447.5

(51) Int. Cl. F25D 23/06

(52) U.S. Cl. CPC F25D 23/066; F25D 23/062; F25D 2201/12

(57) ABSTRACT

A refrigeration appliance device, in particular a household refrigeration appliance device, which achieves a high level of efficiency, includes an inner compartment, which forms a storage space for articles and which is made up at least of a first inner-compartment part and at least of a second inner-compartment part, which is adjacent to the first inner-compartment part and is formed separately from the first inner-compartment part. At least one prefabricated, in particular at least substantially panel-shaped, thermal insulation element, is fastened on at least one side of the inner compartment directed away from the storage space. A refrigeration appliance and/or freezer having the refrigeration appliance device, a modular system for manufacturing the refrigeration appliance device, and a method for producing the refrigeration appliance device, are also provided.

The invention relates to a refrigeration appliance device as claimed in claim 1, a refrigeration appliance and/or freezer as claimed in claim 13, a modular system as claimed in claim 14 and a method for producing a refrigeration appliance device as claimed in claim 15.

The object of the invention is, in particular, to provide a generic device with improved properties regarding an efficiency, in particular a production efficiency. The object is achieved according to the invention by the features of claims 1, 13, 14 and 15, whilst advantageous embodiments and developments of the invention may be derived from the subclaims.

The invention proposes a refrigeration appliance device, in particular a household refrigeration appliance device, having at least one inner compartment, which forms a storage space for refrigerated goods, for example food, and which is made up at least of a first inner-compartment part and at least of a second inner-compartment part which is adjacent to the first inner-compartment part and is formed separately from the first inner-compartment part, wherein in particular either the first inner-compartment part and the second inner-compartment part at the same time form part of an inner compartment box of the inner compartment, or the first inner-compartment part and the second inner-compartment part at the same time form part of an inner compartment cover of the inner compartment, and wherein in particular the first inner-compartment part and the second inner compartment part are connected to one another so as to be positionally fixed relative to one another, and having at least one prefabricated, in particular at least substantially panel-like, thermal insulating element, which is fastened on at least one side of the inner compartment, said side being directed away from the storage space.

In particular, a high level of efficiency may be achieved by such an embodiment. Advantageously, a simple production and/or assembly, which in particular is free of complex foaming processes of cavities and/or complex deep-drawing processes, may be possible. As a result, advantageously a production process may be substantially simplified, in particular since the aforementioned processes of foaming and/or deep-drawing, which may be advantageously dispensed with, require a high degree of specialist knowledge. In a deep-drawing and/or foaming process, new tools are required for each change to the shape, for example, of an inner compartment, which may lead to high system costs which may be advantageously reduced by the proposed embodiment. Moreover, foaming systems have a relatively high space requirement, for example, which may be advantageously reduced by an assembly of prefabricated, supplied insulating elements. Moreover, by means of the simple assembly of prefabricated, supplied insulating elements a production speed may be advantageously increased relative to time-consuming foaming processes. In particular, due to an independence from complex systems, such as for example deep-drawing and/or foaming systems, it is advantageously possible to adapt a number of production parts in a flexible manner. For example, the number of production parts is independent of a number of currently available deep-drawing and/or foaming systems, whereby advantageously a supply chain may be redesigned, made more flexible and/or optimized. Moreover, an efficiency may be advantageously increased by the proposed embodiment, by preparation measures, which are required before a foaming process, for example, such as (manual) sealing and/or preheating of the inner compartment, being able to be dispensed with. Moreover, a sustainability of the production and a recycling at the end of a life cycle may be advantageously increased, in particular by individual parts of the refrigeration appliance device, in particular in contrast to foamed refrigerator insulations, being able to be easily separated again. Moreover, a particularly advantageous modularity, in particular with all of the advantages associated therewith, may be provided by the proposed refrigeration appliance device.

A “refrigeration appliance device”, in particular a “household refrigeration appliance device”, is intended to be understood to mean in particular at least one part, in particular a subassembly, of a refrigeration appliance, in particular a household refrigeration appliance. Particularly advantageously, a household appliance configured as a household refrigeration appliance is provided in the at least one operating state to cool refrigerated goods, in particular food, such as for example beverages, meat, fish, milk and/or dairy products, in particular to achieve a longer shelf life of the refrigerated goods. The household appliance configured as a household refrigeration appliance, in particular, may be a freezer cabinet and advantageously a refrigeration appliance and/or upright freezer. Alternatively, a refrigeration appliance having the refrigeration appliance device could be configured, for example, as an industrial refrigeration appliance, for example for cooling chemicals, production materials or the like, or as a commercial refrigeration appliance for the catering industry or the retail industry, for example for cooling articles for sale, or the like. Moreover, it is conceivable that the refrigeration appliance having the refrigeration appliance device is used in medical facilities, for example for cooling medication or biological material such as blood supplies, etc.

An “inner compartment” is intended to be understood to mean in particular a compartment defining the storage space of a refrigeration appliance at least on five sides, preferably on six sides. In particular, the inner compartment comprises, in particular, a trough-shaped and/or box-shaped inner compartment box. In particular, the inner compartment comprises an inner compartment cover. In particular, the inner compartment is able to be closed at least on one side by the inner compartment cover, which preferably forms a part of a refrigeration appliance door. The inner compartment is configured in particular from a metal, preferably from a plastics material. The inner compartment is produced, in particular, at least to a large part by means of a deep-drawing process, by means of a 3D printing process, by means of a sheet metal bending process or preferably by means of an injection-molding process. A “large part” is intended to be understood to mean in particular at least 51%, preferably at least 66%, preferably at least 80%, and particularly preferably at least 95%. The storage space may be divided, in particular, into a plurality of partial storage spaces which may be cooled, for example, to different temperatures. The storage space or at least a partial storage space may form, in particular, a refrigeration compartment or a freezer compartment of a refrigeration appliance.

The inner compartment, in particular the inner compartment box and/or the inner compartment cover, is made up in particular of at least a plurality of inner-compartment parts configured separately from one another, in particular at least of the first inner-compartment part and the second inner-compartment part. By dividing the inner compartment into sub-elements which are able to be combined together, advantageously a high degree of efficiency may be achieved, in particular by the production, handling and supply being able to be simplified. In particular, the first inner-compartment part and the second inner-compartment part form in each case a part of the inner compartment box, in particular the inner compartment body, which in particular are formed separately from further inner-compartment parts of the inner compartment cover. In particular, the inner compartment box is configured differently and/or separately from the inner compartment cover. In particular, the inner compartment box is not part of a door of the refrigeration appliance and/or freezer, in particular the refrigeration appliance door. It is conceivable that the inner compartment, in particular the inner compartment box and/or the inner compartment cover, is made up of more than two inner-compartment parts, in particular inner-compartment box parts and/or inner-compartment cover parts, for example of three, four, five or more inner-compartment parts. The inner-compartment parts are, in particular, connected to one another such that, in particular apart from small joints, they enclose without gaps the storage space at least on five sides, preferably on six sides. In particular, the inner-compartment parts, in particular the inner-compartment box parts and/or the inner-compartment cover parts, are arranged vertically one above the other in an installation direction of the refrigeration appliance device, in particular of the refrigeration appliance. Alternatively or additionally, the inner-compartment parts, in particular the inner-compartment box parts and/or the inner-compartment cover parts, may be arranged horizontally adjacent to one another in the installation direction of the refrigeration appliance device, in particular of the refrigeration appliance. In particular, adjacent inner-compartment parts are in contact with one another in an assembled state of the inner compartment. In particular, the inner-compartment parts are connected to one another by means of a material connection, for example by means of adhesive bonding, welding and/or fusion, by means of a force-locking connection, for example by means of screwing or riveting, and/or preferably by means of a form-locking connection, for example a latching connection or a plug connection. In particular, in the case of a latching connection or a plug connection, corresponding latching elements or corresponding plug elements may be integrally formed on the inner-compartment parts. In particular, the inner-compartment parts may also be connected to one another by a combination of the aforementioned connecting options.

In particular, the inner compartment box is made up at least of a first inner-compartment box part and at least of a second inner-compartment box part adjacent to the first inner-compartment box part and configured separately from the first inner-compartment box part. In particular, each of the inner-compartment box parts comprises at least one rear wall and two side walls. In particular, each of the inner-compartment box parts forms at least one part of a rear wall of the inner compartment, a part of a left-hand side wall of the inner compartment and a part of a right-hand side wall of the inner compartment. Preferably, a prefabricated, in particular at least substantially panel-like, thermal insulating element is fastened on at least one side of the inner compartment box directed away from the storage space. In particular, the inner compartment cover is made up at least of a first inner-compartment cover part and at least of a second inner-compartment cover part adjacent to the first inner-compartment cover part and configured separately from the first inner-compartment cover part. In particular, the inner-compartment cover parts are at least substantially flat. A “substantially flat” object in this context is intended to be understood to mean in particular an object, the surface extension thereof parallel to a largest side surface of a smallest imaginary cuboid, which only just fully encloses the object, being at least 5 times, preferably at least 10 times, preferably at least 15 times and particularly preferably at least 30 times larger than a surface extension of all of the side surfaces of the smallest imaginary cuboid perpendicular to the largest side surface of the smallest imaginary cuboid. Preferably, a prefabricated, in particular at least substantially panel-like, thermal insulating element is fastened on at least one side of the inner compartment cover directed away from the storage space.

A “thermal insulating element” is intended to be understood to mean in particular an object which is provided to prevent as far as possible a heat flow. An advantage of the invention, in particular, is that a broad spectrum of insulating materials, in particular with different thermal conductivities, may be installed, for example expanded polystyrene, polyurethane or vacuum insulation panels. As a result, advantageously a simple adaptation of the appliance insulations to value classes, different market situations and/or different legal requirements in different countries may be possible. Additionally, by the proposed embodiment a use of simpler foam systems for producing insulating elements may be possible. In particular, the requirements for foams used to produce the insulating elements may be advantageously reduced. For example, requirements for functional properties, such as for example flow behavior, etc. may be reduced in comparison with foaming cavities directly on the appliance. In particular, the insulating element has a particularly low thermal conductivity, which preferably is below 0.25 W/(m*K), advantageously below 0.1 W/(m*K), preferably below 0.051 W/(m*K) and particularly preferably below 0.025 W/(m*K). In particular, the insulating element is configured at least to a large part from a plastics material, preferably a foam material, preferably a hard foam (EPS and/or PU). A “prefabricated” object is intended to be understood to mean in particular an object which, already before being assembled in a device, has at least substantially the shape which it has after the assembly of the device has been completed. In particular, no fundamental change to the shape and/or physical state is required for an assembly of the prefabricated object. The insulating element comprises, in particular at least on one side or on both sides, a carrier element which is configured from paper, felt, metal or plastics material or a combination thereof. The carrier element may advantageously have a supporting effect on an assembly and/or function of the appliance. In particular, the prefabricated object may be prefabricated in a previous production step independent of the assembly. In particular, the prefabricated insulating element is merely supplied for assembly and connected to the inner compartment, in particular, without requiring an additional foaming step. In particular, the prefabricated insulating element is configured differently from cavity foaming, which is subsequently generated from a foam basic material, for example polyurethane, in a cavity at least partially defined by the inner compartment. In particular, the insulating element is different from an in-situ foam and/or an assembly foam. Preferably, the insulating element has an at least substantially non-adhesive surface. A panel-like object is intended to be understood to mean in particular an at least substantially flat object, wherein in particular in this context a “substantially flat” object is intended to be understood to mean an object, the surface extension thereof parallel to the largest side surface of the smallest imaginary cuboid, which only just fully encloses the object, being at least 5 times, preferably at least 10 times, preferably at least 20 times, and particularly preferably at least 30 times greater than the surface extension of all of the side surfaces of the smallest imaginary cuboid perpendicular to the largest side surface of the smallest imaginary cuboid. The panel-like object, in particular, has an at least substantially planar surface which optionally may be provided with cut-outs, through-passages and/or indentations, in particular for integrating functional units. The panel-like insulating elements may advantageously be prefabricated, i.e. already adapted in their size and/or contour during manufacture to a known size and/or contour of the inner compartment and/or an outer casing of the refrigeration appliance device. Moreover, different prefabricated insulating elements may have different materials, thicknesses, densities or the like, in particular as a function of the respective insulating requirements. Alternatively, an insulating element may also encompass at least one corner of the inner compartment and thus be fastened to more than just one side of the inner compartment. In particular, the insulating element is provided to fill at least a large part of an intermediate space between the inner compartment and the outer casing of the refrigeration appliance device. The insulating element being “fastened” to the inner compartment is intended to be understood to mean in particular that the insulating element is connected by a material, form-locking and/or force-locking connection to the inner compartment. In particular, the insulating element is fastened in a positionally fixed manner to the inner compartment. In particular, the refrigeration appliance device is free of a frame unit which is configured, in particular, separately from the inner compartment, the insulating elements and/or the outer casing, and/or which stabilizes and/or retains the inner compartment and/or the insulating elements. In particular, the refrigeration appliance device has a sufficiently high level of stability per se, whereby advantageously an additional frame unit, which in particular generates costs, may be dispensed with. In particular, the refrigeration appliance device is free of additional stabilizing elements which are configured separately from the inner compartment, the insulating elements and/or the outer casing and which are provided to support a weight force of at least one insulating element and/or at least one inner-compartment part directly or indirectly on a substrate and/or to provide the refrigeration appliance device with a greater stiffness. Preferably at least a large part of the insulating elements, preferably each insulating element, is in contact with at least one further insulating element. “Provided” is intended to be understood to mean in particular specifically designed and/or equipped. An object being provided for a specific function is intended to be understood to mean in particular that the object fulfils and/or performs this specific function in at least one use state and/or operating state.

Moreover, the insulating element may be configured as a stacked insulating element. As a result, advantageously a modularity may be further increased. In particular, advantageously a desired insulation may be precisely adapted thereby, for example via an accurate adjustment of a total thickness of an insulating layer by stacked insulating elements. A stacked insulating element comprises two or more separately manufactured insulating elements. The individual insulating elements of the stacked insulating element are combined to form a stack, in particular either before being assembled on the inner compartment, or attached in layers to the inner compartment when assembled on the inner compartment. The individual insulating elements of the stacked insulating element are configured, in particular, from identical materials or at least partially from different materials. For example, one of the insulating elements of the stacked insulating element, which is arranged on at least one outer face of the stacked insulating element, may be configured from an expanded polystyrene (EPS), and a further insulating element of the stacked insulating element, which is arranged in an interior of the stacked insulating element, may be configured from a polyurethane. As a result, an advantageous combination of a good surface formability (EPS) and a cost-effective, advantageously effective insulation (polyurethane) may be achieved. It is additionally conceivable that, with a suitable choice of the individual insulating elements of the stacked insulating element, a diffusion of moisture which impairs the insulation may be reduced.

It is also proposed that the insulating element is fastened at least form-lockingly to the inner compartment. As a result, advantageously a high degree of efficiency may be achieved, in particular by a particularly simple and/or rapid assembly of the insulating elements being able to be permitted. Advantageously, as a result, additional time-consuming operating steps, such as for example applying an adhesive, welding, fusion, screwing and/or riveting may be dispensed with. Moreover, advantageously an adhesion of the insulating element to the inner compartment may be prevented, so that a repair or recycling may be facilitated. In particular, the insulating element is positioned onto form-locking retaining elements configured as sharp pins, which in particular in an assembled state penetrate the insulating element. “Form-lockingly” is intended to be understood to mean in particular that surfaces of components which bear against one another and which are form-lockingly connected to one another exert a retaining force on one another, acting in a direction perpendicular to the surfaces. In particular, the components are geometrically engaged with one another.

It is further proposed that the refrigeration appliance device has at least one prefabricated further thermal insulating element which is fastened, in particular at least form-lockingly, on at least one further side of the inner compartment directed away from the storage space. As a result, a high level of efficiency may be advantageously achieved, in particular by the largest possible outer surface of the inner compartment being able to be insulated toward the outside. Additionally, a high level of modularity may be advantageously achieved. Moreover, advantageously a precise prefabrication of the insulating elements, in particular an adaptation of the insulating elements to the inner compartment, may be possible. In particular, the insulating element and the further insulating element are configured at least substantially identically to one another, preferably with the exception of an outer shape and/or outer contour. In particular, the insulating element and the further insulating element are configured separately from one another. In particular, the side is different from the further side. In particular, viewed from a front face of the inner compartment, the insulating element is arranged on the bottom side, ceiling side, rear side, door side, left-hand side and/or right-hand side relative to the inner compartment. In particular, viewed from the front side of the inner compartment, the further insulating element is arranged on the bottom side, ceiling side, rear side, door side, left-hand side and/or right-hand side relative to the inner compartment.

If the insulating element covers at least to a large part at least the side of the inner compartment directed away from the storage space, in particular the surface of the side of the inner compartment, advantageously a high level of efficiency may be achieved, in particular by the largest possible outer surface of the inner compartment being able to be insulated toward the outside. In particular, the further insulating element covers at least to a large part the further side of the inner compartment directed away from the storage space.

It is further proposed that the insulating element is made up of at least one first partial insulating element and at least one second partial insulating element. As a result, advantageously a high level of efficiency may be achieved in particular by the production, handling and supply of the insulating elements being able to be simplified due to smaller part sizes. Moreover, advantageously a high level of modularity and/or flexibility may be achieved. For example, advantageously identical partial insulating elements may be used for inner compartments of different refrigeration appliances. Moreover, it is conceivable that the insulating element is made up of more than two partial insulating elements, for example from three, four, five or more than five partial insulating elements. In particular, the partial insulating elements have an at least substantially identical thickness, preferably at least in edge regions. “Substantially identical” is intended to be understood to mean in particular at least 80%, preferably at least 90% and preferably at least 95% identical. In particular, each further insulating element may also be made up of partial insulating elements.

If the first partial insulating element and the second partial insulating element are able to be form-lockingly connected to one another, advantageously a high level of efficiency may be achieved, in particular by a particularly simple and/or particularly rapid ease of assembly. Advantageously, a faulty assembly of the insulating elements may be avoided thereby. Moreover, an advantageous modularity may be further improved. In particular, the partial insulating elements have corresponding edge regions. In particular, an edge region of the first partial insulating element which is provided for connecting to an edge region of the second partial insulating element is uneven, wherein the unevenness of the two partial insulating elements correspond to one another. In particular, the edge regions of the two partial insulating elements have corresponding form-locking-connection elements. In particular, the corresponding form-locking-connection elements are provided for a puzzle-like connection of the partial insulating elements to one another. In particular, the form-locking-connection elements are configured integrally with the respectively associated partial insulating elements. “Integrally” is intended to be understood to mean in particular formed in one piece. Preferably, this one piece is produced from a single molded body, a compound and/or a casting, particularly preferably in a foaming, stamping and/or pressing method.

Moreover, it is proposed that a shape, in particular a surface shape and/or a contour, of the insulating element and/or the further insulating element on a side of the insulating element and/or of the further insulating element facing the inner compartment is at least substantially adapted to an outer shape of the side of the inner compartment directed away from the storage space. As a result, advantageously a particularly high level of stability of the refrigeration appliance device and/or a particularly good thermal insulation of the inner compartment may be achieved. Moreover, the situation may be advantageously avoided that the inner compartment has regions in which the insulation does not bear closely against the surface of the inner compartment directed away from the storage space, and thus in some regions is able to be indented and/or pushed in. A divided and injection-molded inner compartment, in particular, also has the advantage relative to a deep-drawn inner compartment that the injection-molded inner compartment may be designed to be significantly more stable with an identical wall thickness. For example, the stability of the inner compartment may be increased in a targeted manner by a ribbing of the inner compartment, which may be implemented in a simple manner by means of the injection-molding method on the sides of the inner compartment directed away from the storage space, in particular at critical points. As a result, the inner compartment may advantageously form a body which is stable per se, independently of any insulating elements such as foamings, etc. or metal plates. In particular, the insulating element has a corresponding elevation in regions in which the inner compartment has an indentation, and a corresponding indentation in regions in which the inner compartment has an elevation, wherein in particular the corresponding elevations and indentations of the insulating element and the inner compartment engage in one another in an assembled state of the refrigeration appliance device. In particular, the insulating element may form a molded body which is adapted at least to a partial region of the inner compartment. In particular, a shape, in particular a surface shape and/or a contour, of the further insulating element on a side of the insulating element facing the inner compartment, is adapted at least substantially to an outer shape of the further side of the inner compartment directed away from the storage space. The refrigeration appliance device advantageously provides a dual flexibility. In particular, either the insulating elements may be adapted to the inner compartment or the inner compartment may be adapted to the insulating elements.

If the refrigeration appliance device also has an outer casing, wherein a shape, in particular a surface shape and/or a contour, of the insulating element and/or the further insulating element on a side of the insulating element and/or the further insulating element directed away from the inner compartment is at least substantially adapted to a shape, in particular a surface shape and/or a contour, of a side of the outer casing facing the storage space, advantageously a particularly high level of stability of the refrigeration appliance device and/or a particularly good thermal insulation of the inner compartment may be achieved. Moreover, a particularly high level of compactness of the refrigeration appliance device may be advantageously achieved. In particular, the outer casing is configured from a metal, for example aluminum or sheet steel. In particular, the outer casing is configured in one piece, preferably integrally. Alternatively, however, the outer casing may also be configured in multiple pieces. In particular, in the assembled state the outer casing covers and/or encloses at least the left-hand and the right-hand insulating elements and the ceiling-side insulating elements of the refrigeration appliance device. It is additionally conceivable that the outer casing also covers and/or encloses the rear-side and/or the bottom-side insulating elements of the refrigeration appliance device. In particular, the insulating element which is assigned to the inner compartment cover is covered by a further outer casing configured separately from the outer casing, in particular a door outer casing. It is also conceivable that the insulating element is fastened by a force-locking, form-locking and/or material connection to the outer casing. Alternatively, the outer casing simply bears loosely against the insulating elements.

It is additionally proposed that the refrigeration appliance device has a functional unit, for example a condenser line, a cable, a vacuum insulation panel, an electronic unit or the like, which is arranged on a side of the insulating element and/or of the further insulating element directed away from the inner compartment, and which has at least a shape, in particular a surface shape, a contour and/or a recess which is at least substantially adapted to a shape, in particular a surface shape and/or contour, of the functional unit. As a result, a particularly high level of stability of the refrigeration appliance device and/or a particularly good thermal insulation of the inner compartment may be advantageously achieved. Moreover, a particularly high level of compactness of the refrigeration appliance device may be advantageously achieved. A “functional unit” is intended to be understood to mean in particular a component which fulfills at least one, in particular technical, function inside the refrigeration appliance to which the refrigeration appliance device is assigned. In particular, the functional unit may be fixed directly to the inner compartment or directly to the outer casing.

It is additionally proposed that the insulating element and/or the further insulating element is at least partially configured from an expanded polystyrene (EPS), in particular pressed to form a molded body. As a result, a high level of efficiency, in particular production efficiency, may be advantageously achieved, in particular since expanded polystyrene may be easily brought into a predetermined shape, in particular in comparison with the polyurethane foam widely used in foamed refrigeration appliances. Alternatively, it is conceivable that the insulating element is sawn, milled or cast to form a molded body. Moreover, it is alternatively or additionally conceivable that the insulating element is at least partially configured from a polyurethane foam which is processed, in particular, to form a molded body, or from a polyvinylchloride foam.

In a further aspect of the invention which may be considered on its own or also in combination with at least one aspect, in particular in combination with one aspect, preferably with the aspect of the prefabricated insulating elements, in particular in combination with any of the remaining aspects of the invention, the inner-compartment parts are advantageously configured as integral injection-molded parts, whereby in particular a particularly high level of efficiency, in particular production efficiency, may be achieved. In comparison with deep-drawn inner-compartment parts, complex and cost-intensive deep-drawing systems and/or extruder systems may be dispensed with. Moreover, an injection-molding system which is usually already present, for example for producing separating elements, shelves, for example egg racks, and/or coverings, for example ventilation grilles, which are then assembled in a deep-drawn inner compartment, may be advantageously used for producing the entire inner compartment. Moreover, as a result, in contrast to the deep-drawing process, a modification and/or optimization of an inner-compartment part, in particular to a shape of the inner-compartment part, may be undertaken in a simple manner. Advantageously, as a result a high level of freedom of design may be possible, whereby for example individualized short production runs may be cost-effectively implemented. Advantageously, a wider supplier network may also be obtained since injection-molding is a more widespread technique than deep-drawing, whereby in particular production costs are lowered. Moreover, a production may be significantly simplified, in particular by the combination of injection-molded inner-compartment parts and prefabricated insulating elements. In particular, the requirements for the system technology may be significantly reduced, whereby for example a construction and a commissioning of a new production facility may be significantly accelerated and simplified.

It is further proposed that, at least on a side facing the storage space, the inner compartment has at least one inner edge, the edge radius thereof being less than 10 mm, preferably less than 5 mm, advantageously less than 3 mm, particularly advantageously less than 1.5 mm, preferably less than 0.51 mm and particularly preferably less than 0.3 mm. As a result, advantageously a freedom of design may be further increased, which in particular opens up new technical possibilities. For example, a spacing between receiving rails for shelves for refrigerated goods may be advantageously reduced thereby. Advantageously, as a result, the inner compartment may be designed significantly more precisely, more distinctively and in a more versatile manner. An “edge radius” is intended to be understood to mean in particular, preferably a smallest, radius of curvature of an edge, in particular a curvature of an inner surface of the inner compartment.

Moreover, the invention proposes a refrigeration appliance and/or freezer having the refrigeration appliance device which, in particular, may be produced, repaired and/or recycled significantly more efficiently than a comparable refrigeration appliance and/or freezer with foamed cavities and/or deep-drawn inner compartments.

Moreover, the invention proposes a modular system for manufacturing the refrigeration appliance device, having at least one set of insulating elements with different insulating properties, in particular with different shapes, with different thicknesses, made from different materials and/or with different densities and having at least one set of inner-compartment parts which are provided to be combined to form an inner compartment and to be connected to at least one of the insulating elements, wherein in particular the inner-compartment parts are able to be combined such that a plurality of different inner compartments may be formed by combinations of the inner-compartment parts. As a result, a high level of flexibility and/or high level of efficiency may be achieved, in particular a plurality of different models of refrigeration appliances with different refrigeration appliance devices, i.e. for example with inner compartments having different shapes or different volumes or with different levels of insulation, may be advantageously produced with a minimum degree of effort. A “set” of objects is intended to be understood to mean in particular a plurality of similar objects which have different characteristic features, for example different sizes, different thicknesses, different materials, slightly different shapes, different colors or the like. Advantageously, the objects of a set may be combined in many different ways and/or combined with objects of a further set in many different ways and a plurality of different but similar combined objects, in particular inner compartments and/or insulating elements, may be formed thereby. In particular, in the modular system at least one suitable insulating element, which is configured in particular as an adapted molded body, is assigned to each inner-compartment part.

Moreover, the invention proposes a method for producing the refrigeration appliance device, in particular by using the modular system, wherein at least one thermal insulating element is prefabricated, in particular as a molded body, at least two inner-compartment parts are joined together to form an inner compartment and the insulating element is fastened on the side of the inner compartment directed away from the storage space. Advantageously, a high level of efficiency, in particular production efficiency, may be achieved by this method. In particular, the method for producing the refrigeration appliance device, in particular the production process of the inner compartment, is at least substantially free of method steps in which a basic material of the inner compartment is deep-drawn. In particular, for producing the refrigeration appliance device, in particular the refrigeration appliance and/or freezer, the method is at least substantially free of method steps in which an intermediate space of the refrigeration appliance device, in particular of the refrigeration appliance and/or freezer, is foamed. In particular, in the method for producing the refrigeration appliance device, when manufacturing an insulating element a shape of the insulating element is adapted to at least a part of a shape of the inner compartment and/or to at least a part of a shape of a functional unit of the refrigeration appliance device arranged outside the storage space.

The refrigeration appliance device, the refrigeration appliance and/or freezer, the modular system and/or the method are not intended to be limited hereby to the above-described application and embodiment. In particular, the refrigeration appliance device, the refrigeration appliance and/or freezer, the modular system and/or the method for fulfilling a mode of operation described herein may have a number of individual insulating elements, components and units which differs from a number cited herein.

Further advantages emerge from the following description of the drawings. An exemplary embodiment of the invention is shown in the drawing. The drawing, the description and the claims contain numerous features in combination. The person skilled in the art will also expediently consider the features individually and combine them to form further meaningful combinations.

In the drawing:

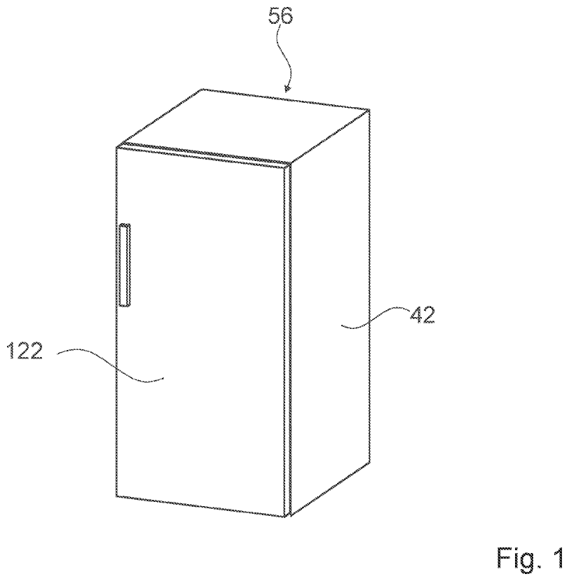

FIG. 1 shows a schematic perspective view of a refrigeration appliance and/or freezer,

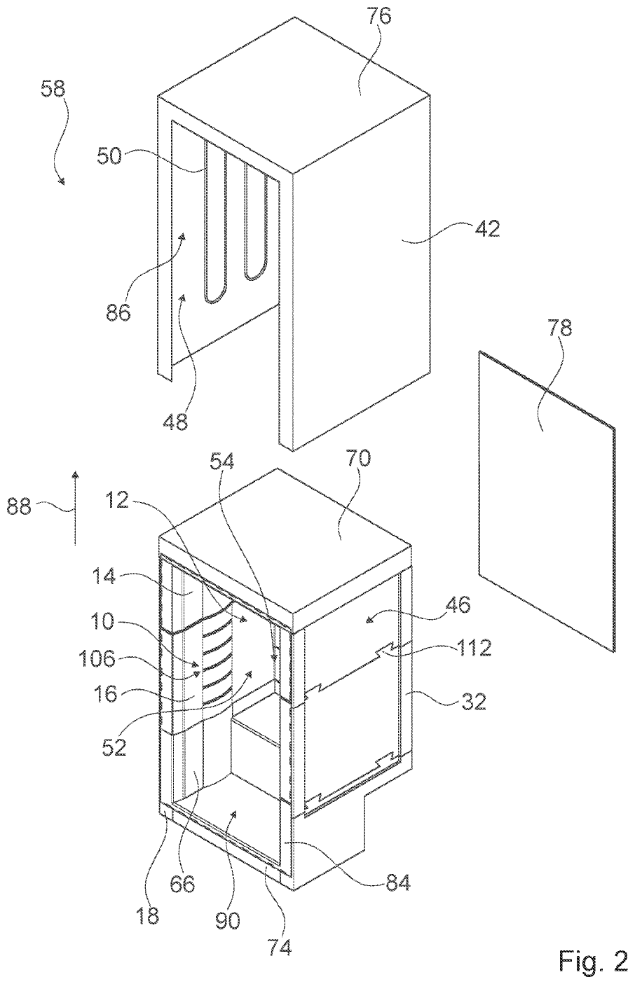

FIG. 2 shows a schematic perspective view of the refrigeration appliance and/or freezer with a refrigeration appliance device with an inner compartment, with an outer casing and with a plurality of insulating elements,

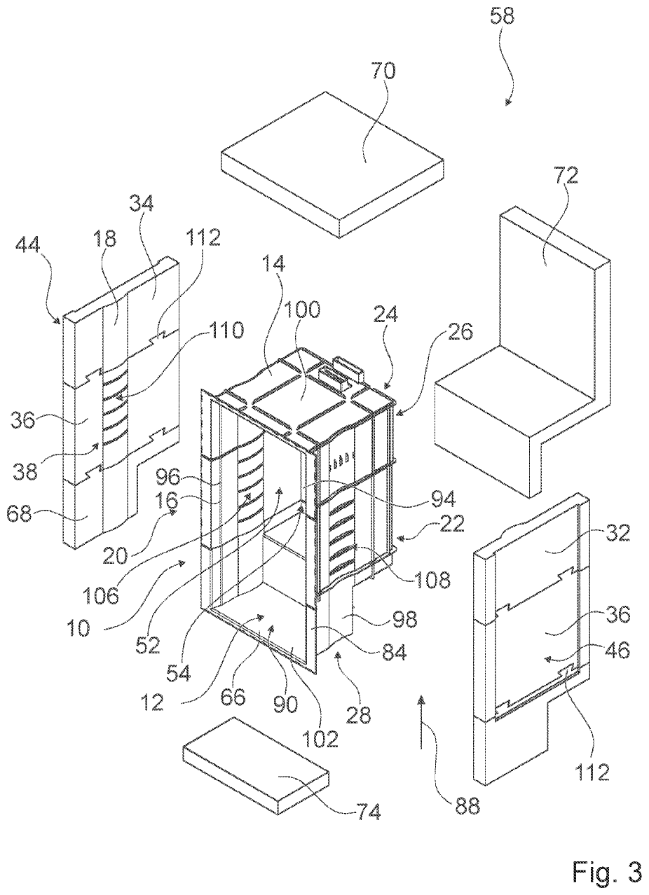

FIG. 3 shows a schematic exploded view of the refrigeration appliance device with a combined inner compartment box of the inner compartment and five separate prefabricated insulating elements,

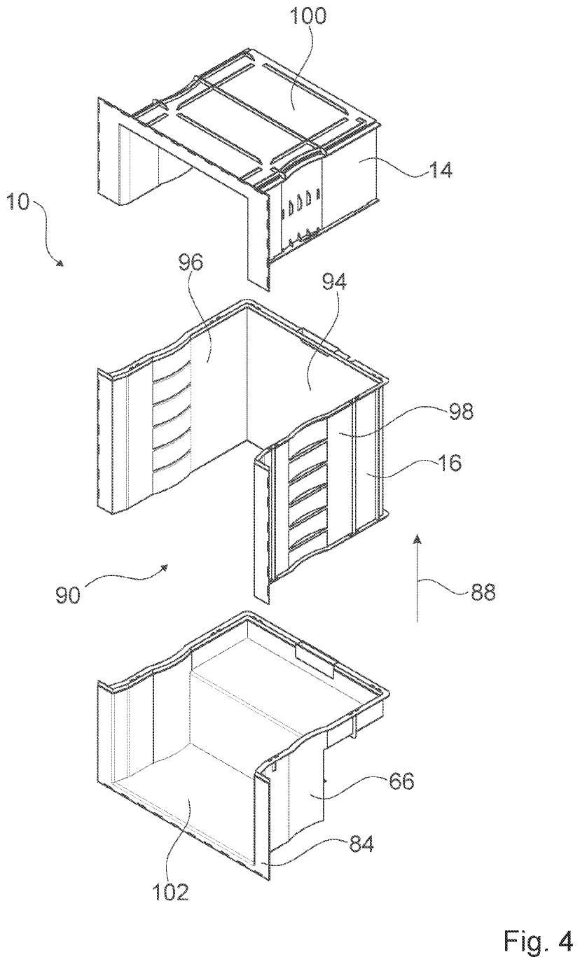

FIG. 4 shows a schematic perspective view of the inner compartment box with three separate inner-compartment parts,

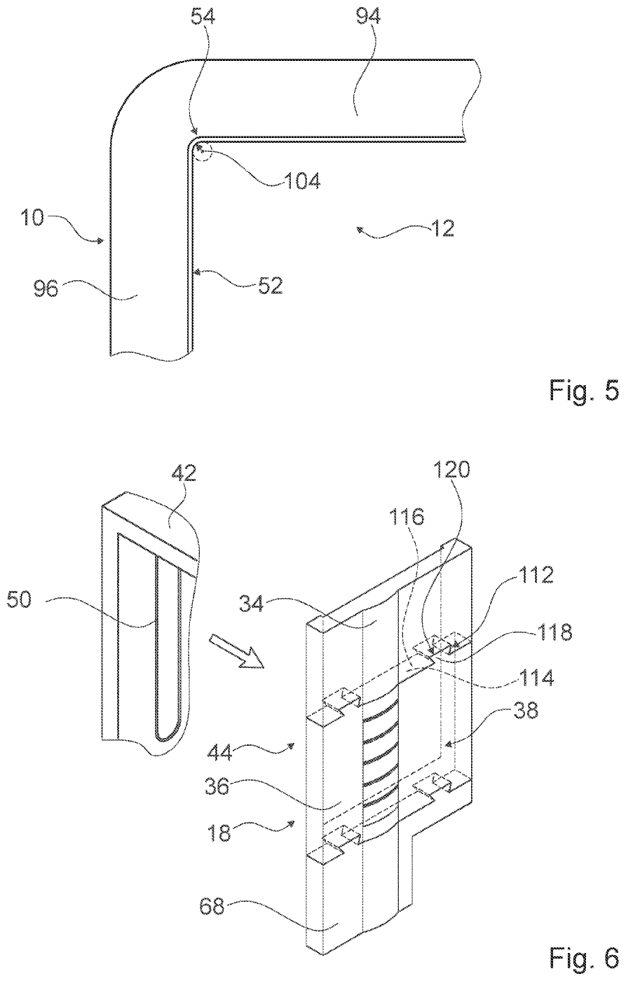

FIG. 5 shows a schematic sectional view of an inner edge of the inner compartment,

FIG. 6 shows a schematic perspective view of a prefabricated insulating element with three partial insulating elements,

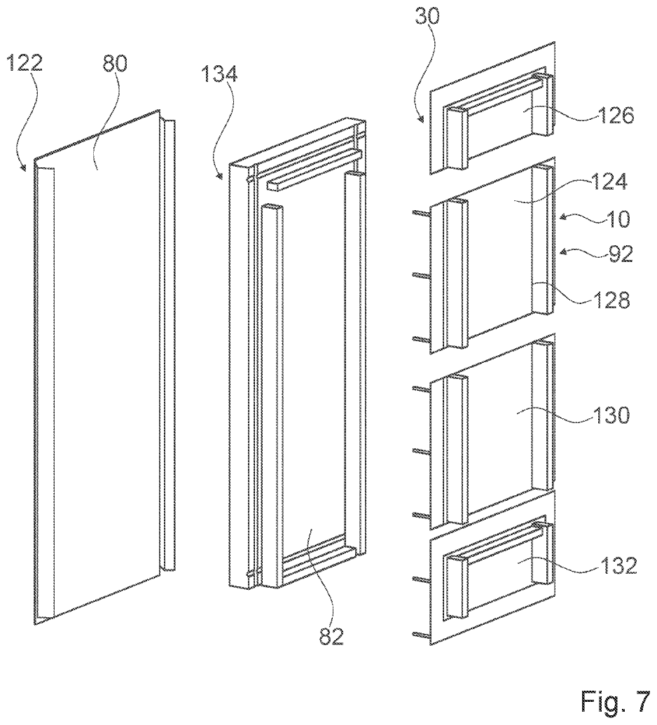

FIG. 7 shows a schematic perspective view of a refrigeration appliance door of the refrigeration appliance and/or freezer with an inner compartment cover of the inner compartment and with an insulating element,

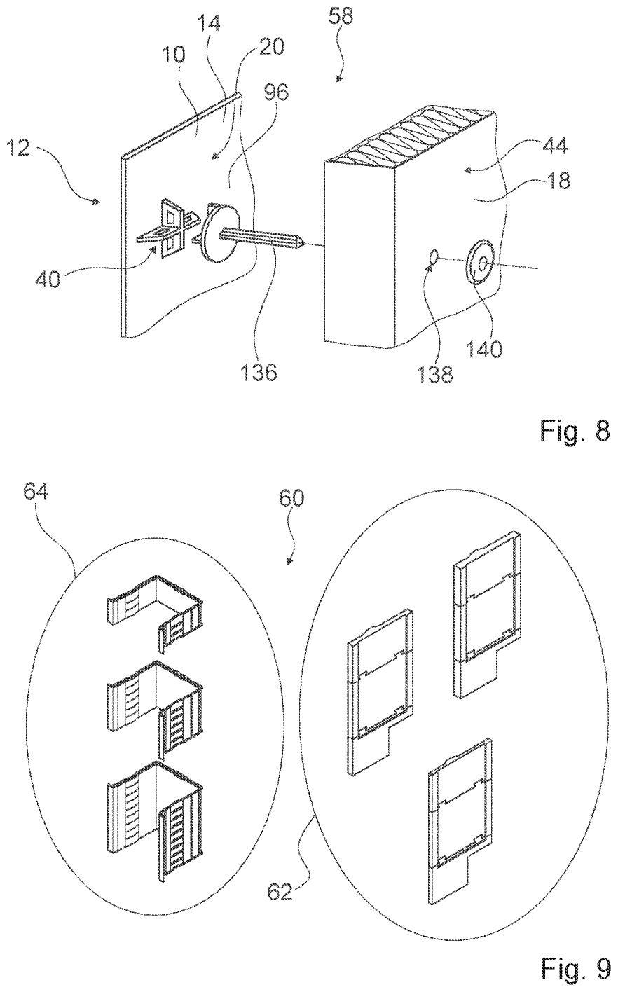

FIG. 8 shows a schematic perspective view of a form-locking fastening between the insulating element and the inner compartment,

FIG. 9 shows a schematic view of an exemplary modular system for manufacturing the refrigeration appliance device and

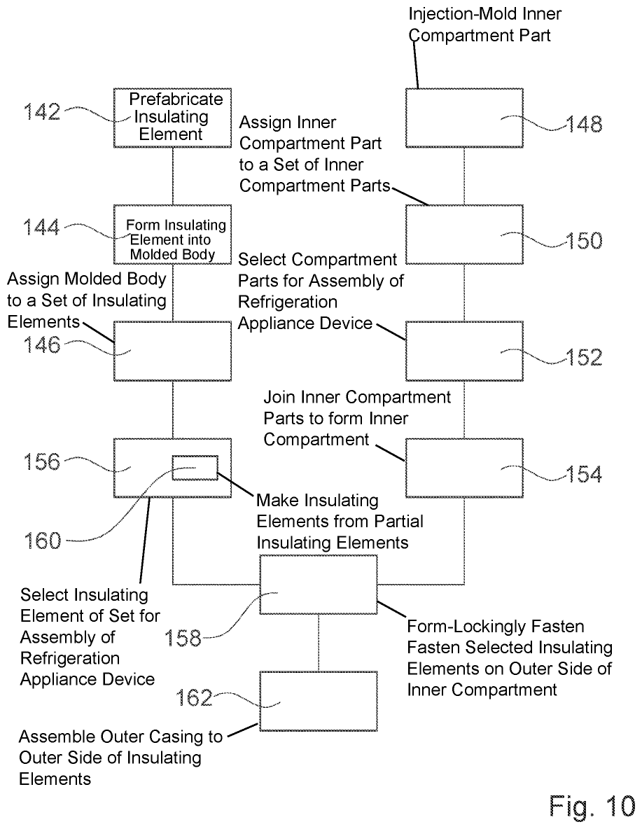

FIG. 10 shows a schematic flow diagram of a method for producing the refrigeration appliance device.

FIGS. 1 and 2 show perspective views of a refrigeration appliance and/or freezer 56. The refrigeration appliance and/or freezer 56 is configured as a household refrigeration appliance. The household refrigeration appliance may be, for example, a refrigeration appliance, a freezer or a combined refrigerator-freezer for use in a private household. The refrigeration appliance and/or freezer 56 is provided for a temperature-controlled storage of refrigerated goods, for example food. The refrigeration appliance and/or freezer 56 has a refrigeration appliance device 58. The refrigeration appliance device 58 has an inner compartment 10. The inner compartment 10 forms a storage space 12. An internal volume of the inner compartment 10 forms the storage space 12. The storage space 12 is provided for receiving the refrigerated goods. The storage space 12 is able to be divided into partial storage spaces by means of shelves for refrigerated goods (not shown), wherein the shelves for refrigerated goods may be fixedly installed in the storage space 12 or may be removable from the storage space 12. The inner compartment 10 shown in FIG. 2 is configured from a plastics material. The inner compartment 10 shown in FIG. 2 is manufactured by means of an injection-molding method.

The refrigeration appliance device 58 has a thermal insulating element 18 (see also FIG. 3). The insulating element 18 thermally insulates the storage space 12 toward the outside. The insulating element 18 is configured as a prefabricated insulating element 18. The insulating element 18 is configured from a hard foam.

Alternatively, it is conceivable that the insulating element 18 may also be configured at least partially or entirely from a soft foam. The insulating element 18 is preferably a panel consisting of PU foam with carrier elements on both sides. Alternatively, the insulating element may also be configured from an expanded polystyrene (EPS) or a combination of EPS and PU. Moreover, alternatively the insulating element 18 may be prefabricated from different thermally insulating materials, in particular hard foams, or configured as a vacuum insulation panel. The inner compartment 10 is covered on a side 20 directed away from the storage space 12 by the prefabricated insulating element 18. The insulating element 18 in this case covers at least to a large part the side 20 of the inner compartment 10 directed away from the storage space 12. The prefabricated insulating element 18 is fastened to the inner compartment 10 on the side 20 directed away from the storage space 12 (see also FIG. 8).

The refrigeration appliance device 58 has a further thermal insulating element 32. The further insulating element 32 is configured as a prefabricated insulating element 32. The inner compartment 10 is covered by the further prefabricated insulating element 32 on a further side 22 which is directed away from the storage space 12 and which is different from the side 20 on which the insulating element 18 is fastened. The further insulating element 32 in this case covers at least to a large part the further side 22 of the inner compartment 10 directed away from the storage space 12. The further prefabricated insulating element 32 is fastened to the inner compartment 10 on the further side 22 directed away from the storage space 12. The inner compartment 10 is surrounded on all sides 20, 22, 24, 26, 28, 30 directed away from the storage space 12 by prefabricated insulating elements 18, 32, 70, 72, 74, 82 configured separately from one another (see also FIG. 3). The insulating elements 18, 32, 70, 72, 74, 82 are fastened to the inner compartment 10 on the side 20, 22, 24, 26, 28, 30 of the inner compartment 10 respectively assigned thereto. All of the sides 20, 22, 24, 26, 28, 30 of the inner compartment 10 are covered at least to a large part by one of the insulating elements 18, 32, 70, 72, 74, 82. The insulating elements 18, 32, 70, 72, 74, 82 are configured at least substantially identically in terms of function, material, density and/or thickness. The insulating elements 18, 32, 70, 72, 74, 82 differ from one another merely in terms of shape and/or contour.

Alternatively, however, it is conceivable that at least one insulating element 18, 32, 70, 72, 74, 82 has a different function, different material, different density and/or different thickness from a further insulating element 18, 32, 70, 72, 74, 82.

The refrigeration appliance device 58 has an outer casing 42. The outer casing 42 is configured from a metal. The outer casing 42 surrounds the inner compartment 10 and the insulating elements 18, 32, 70, 72, 74, 82 fastened to the inner compartment 10 on one or more, preferably all, sides 20, 22, 24, 26, 28, 30 of the inner compartment 10 directed away from the storage space 12. The outer casing 42 defines the refrigeration appliance and/or freezer 56 toward the outside. The outer casing 42 shown in FIG. 2 comprises a plurality of outer casing partial elements 76, 78, 80. A first of the outer casing partial elements 76 is configured to be substantially U-shaped and in an assembled state covers the left-hand, right-hand and ceiling-side insulating elements 18, 32, 70, viewed in a front view. A second outer casing partial element 78 is of panel-like configuration and in the assembled state covers the rear-side insulating element 72. A third outer casing partial element 80 shown in FIG. 7 is of panel-like configuration and in the assembled state covers a front-side, in particular door-side, insulating element 82. Optionally, the outer casing 42 is fastened to at least one of the insulating elements 18, 32, 70, 72, 74, 82 and/or to the inner compartment 10, in particular to a door-side frame 84 of the inner compartment 10. The refrigeration appliance device 58 has a functional unit 50. The functional unit 50 is configured as a condenser line in the exemplary embodiment shown. The functional unit 50 is arranged on a side 44, 46 of the insulating element 18, 32 directed away from the inner compartment 10. The functional unit 50 is fastened to the outer casing 42 on an inner side 86 of the outer casing 42 facing the inner compartment 10.

The inner compartment 10 comprises an inner compartment box 90. The inner compartment 10 comprises an inner compartment cover 92 (see FIG. 7). FIG. 4 shows a part of the inner compartment 10 forming the inner compartment box 90. The inner compartment 10 has a first inner-compartment part 14. The inner compartment 10 has a second inner-compartment part 16. The inner compartment 10 has a third inner-compartment part 66. The first inner-compartment part 14 and the second inner-compartment part 16 are adjacent to one another. The first inner-compartment part 14 and the second inner-compartment part 16 are configured separately from one another. The second inner-compartment part 16 and the third inner-compartment part 66 are adjacent to one another. The second inner-compartment part 16 and the third inner-compartment part 66 are configured separately from one another. The inner compartment 10, in particular the inner compartment box 90, is made up of the inner-compartment parts 14, 16, 66. The inner-compartment parts 14, 16, 66 of the inner compartment box 90 form inner-compartment box parts. Alternatively, the inner compartment 10, in particular the inner compartment box 90, may be made up of more or less than three inner-compartment parts 14, 16, 66. The inner-compartment parts 14, 16, 66 shown in the exemplary embodiment are configured as integral injection-molded parts. The inner-compartment parts 14, 16, 66 are positioned vertically one above the other in an installation direction 88 of the refrigeration appliance device 58. The inner compartment 10 is divided into the separate inner-compartment parts 14, 16, 66 in the installation direction 88. Alternatively or additionally, the inner compartment 10 may be divided, in particular, into further separate inner-compartment parts 14, 16, 66 perpendicular to the installation direction 88. The inner-compartment parts 14, 16, 66 comprise in each case at least one part of a rear wall 94 of the inner compartment 10. The inner-compartment parts 14, 16, 66 comprise in each case at least one part of a first side wall 96 of the inner compartment 10. The inner-compartment parts 14, 16, 66 comprise in each case at least one part of a second side wall 98 of the inner compartment 10 which opposes the first side wall 96 of the inner compartment 10. The first inner-compartment part 14 additionally comprises an upper wall 100 of the inner compartment 10. The third inner-compartment part 66 additionally comprises a lower wall 102 of the inner compartment 10. The inner-compartment parts 14, 16, 66 combined to form the inner compartment box 90 are connected to one another form-lockingly by latching elements, not shown. Alternatively or additionally, the inner-compartment parts 14, 16, 66 may also be divided once or repeatedly in the vertical direction.

FIG. 5 shows a horizontal section through a part of the inner compartment 10. The inner compartment 10 has at least one inner edge 54 on a side 52 facing the storage space 12. The inner edge 54 has an edge radius 104. The edge radius 104 of the inner edge 54 is 1.5 mm. The inner edge 54 shown is merely an example of further inner edges of the inner compartment 10 which are arranged on other parts of the inner compartment 10 and which also may have an edge radius 104 of 1.5 mm or less. The edge radius 104 is, in particular, at least 10% smaller than a minimum edge radius 104 which may be produced by conventional deep-drawing methods.

FIG. 6 shows schematically, and by way of example for all further insulating elements 32, 70, 72, 74, 82, the prefabricated insulating element 18 and a part of the outer casing 42 with the functional unit 50. The insulating element 18 is of panel-like configuration. The insulating element 18 is produced in a continuous foaming process. The insulating element 18 is produced in an external panel production system for producing insulating elements 18. The insulating element 18 may be pressed to form a molded body. On a side 38 of the insulating element 18 facing the inner compartment 10, the insulating element 18 has a shape, in particular a surface shape, which is adapted to an outer shape of the side 20 of the inner compartment 10 directed away from the storage space 12 (see FIG. 3). On the side 38 of the insulating element 18 facing the inner compartment 10, the insulating element 18 has a contour which is adapted to a contour of the side 20 of the inner compartment 10 directed away from the storage space 12 (see FIG. 3). In the side wall 96 facing the insulating element 18 the inner compartment 10 has receiving rails 106 for shelves for refrigerated goods (see FIG. 3). In the side wall 96 facing the insulating element 18 the inner compartment 10 has indentations 108 which are required, in particular, by the receiving rails 106. On the side 38 facing the inner compartment 10 the insulating element 18 has elevations 110 corresponding to the indentations 108. In an assembled state of the refrigeration appliance device 58 the elevations 110 engage in the indentations 108 of the inner compartment 10. As a result, a reinforcement of the receiving rails 106 may be advantageously achieved. Alternatively, in particular in the case of an injection-molded inner compartment 10, in addition to the engagement of the insulating element 18 or instead of an engagement of the insulating element 18, the receiving rail 106 could have vertically or obliquely running reinforcing ribs (not shown) on a side directed away from the storage space 12.

On the side 44 of the insulating element 18 directed away from the inner compartment 10 the insulating element 18 has a shape which is adapted to a shape of a side 48 of the outer casing 42 facing the storage space 12. On the side 44 of the insulating element 18 directed away from the inner compartment 10 the insulating element 18 has a contour which is adapted to a contour of the side 48 of the outer casing 42 facing the storage space 12. The insulating element 18 has a shape, in particular a surface shape, which is adapted to a shape, in particular a surface shape, of the functional unit 50. The insulating element 18 has a contour which is adapted to a shape, in particular a surface shape, of the functional unit 50. The insulating element 18 has a recess which is adapted to a shape, in particular a surface shape, of the functional unit 50.

The insulating element 18 has a first partial insulating element 34. The insulating element 18 has a second partial insulating element 36. The insulating element 18 has a third partial insulating element 68. The insulating element 18 is made up of the first partial insulating element 34, the second partial insulating element 36 and the third partial insulating element 68. Alternatively, the insulating element 18 may be made up of more or less than three partial insulating elements 34, 36, 68. The partial insulating elements 34, 36, 68 shown in the exemplary embodiment are configured as integral hard foam parts. The partial insulating elements 34, 36, 68 are positioned vertically one above the other in the assembled state of the refrigeration appliance device 58 in the installation direction 88 of the refrigeration appliance device 58. The insulating element 18 is divided into the separate partial insulating elements 34, 36, 68 in the installation direction 88. Alternatively or additionally, the insulating element 18 may be divided into, in particular, further separate partial insulating elements perpendicular to the installation direction 88. The partial insulating elements 34, 36, 68 are able to be form-lockingly connected to one another. The partial insulating elements 34, 36, 68 have form-locking-connection elements 112 which correspond to one another and which engage in one another to connect two respective partial insulating elements 34, 36, 68. In the exemplary embodiment shown, for example, the second partial insulating element 36 has a form-locking-fit element 118 on a first side edge 114. The first partial insulating element 34 has on a second side edge 116 a form-locking-connection recess 120 corresponding to the form-locking-fit element 118 of the second partial insulating element 36. For the form-locking connection of the first partial insulating element 34 to the second partial insulating element 36, the form-locking-fit element 118 of the second partial insulating element 36 engages in the form-locking-connection recess 120 of the first partial insulating element 34.

FIG. 7 shows a refrigeration appliance door 122 of the refrigeration appliance and/or freezer 56. The refrigeration appliance door 122 comprises a part of the inner compartment 10. The refrigeration appliance door 122 comprises the inner compartment cover 92. In a closed state of the refrigeration appliance door 122, the inner compartment cover 92 forms a front wall 124 of the inner compartment 10. The inner compartment cover 92 is made up of a plurality of inner-compartment parts 126, 128, 130, 132, similar to the inner compartment box 90. The inner-compartment parts 126, 128, 130, 132 of the inner compartment cover 92 form inner-compartment cover parts. Apart from the shaping, the inner-compartment parts 126, 128, 130, 132 of the inner compartment cover 92 correspond to the inner-compartment parts 14, 16, 66 of the inner compartment box 90. The inner compartment cover 92 is covered on a side 30 directed away from the storage space 12 by the door-side insulating element 82. The door-side insulating element 82 is connected form-lockingly to the inner compartment cover 92. The door-side insulating element 82 is covered by the third outer casing partial element 80 on a side 134 directed away from the inner compartment cover 92.

The insulating element 18 is form-lockingly fastened to the inner compartment 10. FIG. 8 shows the form-locking fastening of one of the insulating elements 18 to the inner compartment 10. The inner compartment 10 has a fastening unit 40. The fastening unit 40 is configured integrally with the injection-molded inner compartment 10. The fastening unit 40 is form-lockingly connected to a plug element 136 of the refrigeration appliance device 58. By a form-locking connection with the insulating element 18 and in cooperation with the fastening unit 40, the plug element 136 brings about a positionally fixed retention of the insulating element 18 relative to the inner compartment 10. For connecting the insulating element 18 to the inner compartment 10, the plug element 136 is plugged into a recess 138 of the insulating element 18 or directly into the material of the insulating element 18. In an assembled state, the plug element 136 fully penetrates the insulating element 18. The refrigeration appliance device 58 has a securing element 140. The securing element 140 secures the connection generated by the fastening unit 40 between the inner compartment 10 and the insulating element 18 against being automatically released. The securing element 140 is configured as a circlip. The insulating element 18 is able to be connected to the inner compartment 10 by means of plug elements 136 and securing elements 140 without the use of tools and/or without the use of adhesive.

FIG. 9 shows a modular system 60 for manufacturing different but similar refrigeration appliance devices 58. The modular system 60 has a set 62 of insulating elements 18, 32, 70, 72, 74, 82. The insulating elements 18, 32, 70, 72, 74, 82 of a set 62 are in each case made up of partial insulating elements 34, 36, 68. The insulating elements 18, 32, 70, 72, 74, 82 of a set 62 are respectively assigned to exactly one side 20, 22, 24, 26, 28, 30 of the inner compartment 10. The modular system 60 comprises a plurality of sets 62 of insulating elements 18, 32, 70, 72, 74, 82 respectively for other sides 20, 22, 24, 26, 28, 30 of the inner compartment 10. The insulating elements 18, 32, 70, 72, 74, 82 of a set 62 have different insulating properties, for example different shapes, different thicknesses, different materials and/or different densities. The modular system 60 has a set 64 of inner-compartment parts 14, 16, 66, 126, 128, 130, 132 which are provided to be combined to form different inner compartments 10 and to be connected to at least the insulating elements 18, 32, 70, 72, 74, 82 of a set 62 of insulating elements 18, 32, 70, 72, 74, 82. The modular system 60 is advantageously able to be extended and/or modified in any manner.

FIG. 10 shows a schematic flow diagram of a method for producing the refrigeration appliance device 58. In at least one method step 142, an insulating element 18, 32, 70, 72, 74, 82 is prefabricated. In at least one further method step 144, the prefabricated insulating element 18, 32, 70, 72, 74, 82 is pressed to form a molded body, so that the shape of the insulating element 18, 32, 70, 72, 74, 82 is adapted to a shape of the inner compartment 10. In at least one further method step 146, the molded body is assigned one of the sets 62 of insulating elements 18, 32, 70, 72, 74, 82 of the modular system 60. In at least one further method step 148, an inner-compartment part 14, 16, 66, 126, 128, 130, 132 is produced by injection-molding. In at least one further method step 150, the inner-compartment part 14, 16, 66, 126, 128, 130, 132 is assigned to the set 64 of inner-compartment parts 14, 16, 66, 126, 128, 130, 132 of the modular system 60. In at least one further method step 152, at least two inner-compartment parts 14, 16, 66, 126, 128, 130, 132 of the set 64 of inner-compartment parts 14, 16, 66, 126, 128, 130, 132 are selected for the assembly of the refrigeration appliance device 58. In at least one further method step 154, the at least two inner-compartment parts 14, 16, 66, 126, 128, 130, 132 are joined together to form an inner compartment 10. In at least one further method step 156, at least one insulating element 18, 32, 70, 72, 74, 82 from one of the sets 62 of insulating elements 18, 32, 70, 72, 74, 82 is selected for an assembly of the refrigeration appliance device 58. Optionally in a sub-method step 160 of the method step 156, the insulating element 18, 32, 70, 72, 74, 82 is made up of partial insulating elements 34, 36, 68. In at least one further method step 158, the selected insulating element 18, 32, 70, 72, 74, 82 is form-lockingly fastened on the side 20, 22, 24, 26, 28, 30 of the combined inner compartment 10 directed away from the storage space 12. In at least one further method step 162, after fastening all of the insulating elements 18, 32, 70, 72, 74, 82 to the inner compartment 10, the outer casing 42 is assembled on the side 44, 46 of the insulating elements 18, 32, 70, 72, 74, 82 directed away from the inner compartment 10.

### REFERENCE NUMERALS

10 Inner compartment
12 Storage space
14 First inner-compartment part
16 Second inner-compartment part
18 Insulating element
20 Side
22 Side
24 Side
26 Side
28 Side
30 Side
32 Further insulating element
34 First partial insulating element
36 Second partial insulating element
38 Side
40 Fastening unit
42 Outer casing
44 Side
46 Side
48 Side
50 Functional unit
52 Side
54 Inner edge
56 Refrigeration appliance and/or freezer
58 Refrigeration appliance device
60 Modular system
62 Set
64 Set
66 Third inner-compartment part
68 Third partial insulating element
70 Ceiling-side insulating element
72 Rear-side insulating element
74 Bottom-side insulating element
76 First outer casing partial element
78 Second outer casing partial element
80 Third outer casing partial element
82 Door-side insulating element
84 Frame
86 Inner face
88 Installation direction
90 Inner compartment box
92 Inner compartment cover
94 Rear wall
96 First side wall
98 Second side wall
100 Upper wall
102 Lower wall
104 Edge radius
106 Receiving rail
108 Indentation
110 Elevation
112 Form-locking-connection element
114 First side edge
116 Second side edge
118 Form-locking-fit element
120 Form-locking connection recess
122 Refrigeration appliance door
124 Front wall
126 Inner-compartment part
128 Inner-compartment part
130 Inner-compartment part
132 Inner-compartment part
134 Side
136 Plug element
138 Recess
140 Securing element
142 Method step
144 Method step
146 Method step
148 Method step
150 Method step
152 Method step
154 Method step
156 Method step
158 Method step
160 Partial method step
162 Method step

1-15. (canceled)

16. A refrigeration appliance device or household refrigeration appliance device, comprising:
at least one inner compartment forming a storage space for refrigerated goods, said at least one inner compartment having at least one side directed away from said storage space, said at least one inner compartment including at least one first inner-compartment part and at least one second inner-compartment part, said at least one second inner-compartment part disposed adjacent to said first inner-compartment part and formed separately from said first inner-compartment part; and
at least one prefabricated or at least substantially panel-shaped thermal insulating element fastened on said at least one side of said at least one inner compartment directed away from said storage space.

17. The refrigeration appliance device according to claim 16, wherein said at least one insulating element is at least form-lockingly fastened to said at least one inner compartment.

18. The refrigeration appliance device according to claim 16, wherein said at least one inner compartment has at least one further side directed away from said storage space, and at least one prefabricated further thermal insulating element is fastened or at least form-lockingly fastened on said at least one further side of said at least one inner compartment directed away from said storage space.

19. The refrigeration appliance device according to claim 16, wherein said at least one insulating element covers at least a majority of said at least one side of said at least one inner compartment directed away from said storage space.

20. The refrigeration appliance device according to claim 16, wherein said at least one insulating element includes at least one first partial insulating element and at least one second partial insulating element.

21. The refrigeration appliance device according to claim 20, wherein said first partial insulating element and said second partial insulating element are configured to be form-lockingly connected to one another.

22. The refrigeration appliance device according to claim 16, wherein said at least one insulating element includes a side facing said at least one inner compartment and having a shape or at least one of a surface shape or contour being at least substantially adapted to an outer shape of said at least one side of said at least one inner compartment directed away from said storage space.

23. The refrigeration appliance device according to claim 16, which further comprises an outer casing, said at least one insulating element including a side being directed away from said at least one inner compartment and having a shape or at least one of a surface shape or contour being at least substantially adapted to a shape or at least one of a surface shape or contour of a side of said outer casing facing said storage space.

24. The refrigeration appliance device according to claim 16, which further comprises a functional unit having a shape, said at least one insulating element including a side being directed away from said at least one inner compartment and having a shape or at least one of a surface shape or contour or recess being at least substantially adapted to said shape of said functional unit, said functional unit being disposed on said of said at least one insulating element directed away from said at least one inner compartment.

25. The refrigeration appliance device according to claim 16, wherein said at least one insulating element is at least partially formed of an expanded polystyrene or a pressed molded body.

26. The refrigeration appliance device according to claim 16, wherein said at least one first and said at least one second inner-compartment parts are integral injection-molded parts.

27. The refrigeration appliance device according to claim 16, wherein said at least one inner compartment includes a side facing said storage space, and at least said side of said at least one inner compartment facing said storage space has at least one inner edge with an edge radius of less than 10 mm.

28. At least one of a refrigeration appliance or a freezer, comprising a refrigeration appliance device according to claim 16.

29. A modular system for manufacturing a refrigeration appliance device according to claim 16, the modular system comprising:
at least one set of insulating elements having at least one of different insulating properties or different shapes or different thicknesses or being formed of different materials or having different densities; and
at least one set of inner-compartment parts to be combined to form an inner compartment and to be connected to at least one of said insulating elements, said inner-compartment parts configured to be combined to form a plurality of different inner compartments from combinations of said inner-compartment parts.

30. A modular system for manufacturing at least one of a refrigeration appliance or a freezer according to claim 28, the modular system comprising:
at least one set of insulating elements having at least one of different insulating properties or different shapes or different thicknesses or being formed of different materials or having different densities; and
at least one set of inner-compartment parts to be combined to form an inner compartment and to be connected to at least one of said insulating elements, said inner-compartment parts configured to be combined to form a plurality of different inner compartments from combinations of said inner-compartment parts.

31. A method for producing a refrigeration appliance device according to claim 16, the method comprising:
prefabrication at least one thermal insulating element or molded body;
joining at least two inner-compartment parts together to form an inner compartment; and
fastening the at least one insulating element or molded body on a side of the inner compartment directed away from the storage space.

32. A method for producing a refrigeration appliance device by using the modular system according to claim 29, the method comprising:
prefabrication at least one thermal insulating element or molded body;
joining at least two inner-compartment parts together to form an inner compartment; and
fastening the at least one insulating element or molded body on a side of the inner compartment directed away from the storage space.

33. A method for producing a refrigeration appliance device by using the modular system according to claim 30, the method comprising:
prefabrication at least one thermal insulating element or molded body;
joining at least two inner-compartment parts together to form an inner compartment; and
fastening the at least one insulating element or molded body on a side of the inner compartment directed away from the storage space.
